(19) United States
(12) Patent Application Publication
(10) Pub. No.: US 2025/0324027 A1
(43) Pub. Date: Oct. 16, 2025

(54) MULTIPLANE NANOPHOTONIC VOXEL ENGINE

(71) Applicants: The MITRE Corporation, McLean, VA (US); Massachusetts Institute of Technology, Cambridge, MA (US)

(72) Inventors: Dirk R. ENGLUND, Brookline, MA (US); Artur Hermans, Boston, MA (US); Mark Dong, Somerville, MA (US)

(73) Assignees: The MITRE Corporation, McLean, VA (US); Massachusetts Institute of Technology, Cambridge, MA (US)

(21) Appl. No.: 18/438,110

(22) Filed: Feb. 9, 2024

Related U.S. Application Data
(60) Provisional application No. 63/484,225, filed on Feb. 10, 2023.

(51) Int. Cl. H04N 13/388; H04N 13/365

(52) U.S. Cl. CPC H04N 13/388; H04N 13/365

(57) ABSTRACT

Described are systems and methods for projecting multiplane 3D images using a multiplane nanophotonic voxel engine. The multiplane nanophotonic voxel engine may include a laser light source and a photonic integrated circuit. The photonic integrated circuit may include a plurality of beam-steering cantilevers and a plurality of modulators. The plurality of beam-steering cantilevers may be piezoelectrically actuated beam-steering cantilevers. Each piezoelectrically actuated beam-steering cantilever may comprise a plurality of embedded waveguides that can emit light in various directions based on the actuation of the cantilever in order to generate a portion of an image.

### CROSS-REFERENCE TO RELATED APPLICATIONS

This application claims the benefit of U.S. Provisional Application No. 63/484,225, filed Feb. 10, 2023, the entire contents of which is incorporated herein by reference.

### STATEMENT REGARDING FEDERALLY SPONSORED RESEARCH OR DEVELOPMENT

This invention was made with government support under U.S. Government Contract No. FA8750-20-2-1007, awarded by The U.S. Air Force. The government has certain rights in the invention.

### FIELD

The present disclosure relates generally to multiplane light projection systems. More specifically, the present disclosure relates to systems and methods for using a multiplane nanophotonic voxel engine.

### BACKGROUND

The industry standard for 3D displays is a stereoscopic display, in which a user's left eye and right eye are shown slightly different images. However, stereoscopic 3D displays can cause vergence-accommodation conflict, which can lead to headaches, visual fatigue and discomfort. Vergence-accommodation conflict occurs when the brain receives mismatching cues between vergence and accommodation. Vergence is the simultaneous movement of both eyes in opposite directions to maintain single binocular vision, while accommodation refers to the process by which the eye changes optical power to maintain focus on an object as its distance changes.

Multiplane 3D displays do not cause vergence-accommodation conflict. However, existing multiplane 3D display technology is unable to achieve essential characteristics, such as a large number of simultaneous projection planes, a large number of spatially resolved pixels, a high device pixel density, a high refresh rate, low power consumption, several color channels, and a high contrast ratio.

Existing multiplane projection systems can generate images in multiple image planes at different distances using various multiplane projection methods. A first existing method involves projecting multiple object planes to multiple image planes using a fixed focal length. However, existing systems that use this method are bulky and limited in the number of image planes that can be projected. A second existing method involves varying focal length so that a fixed object plane is projected to different image planes. However, existing systems that use this method may also be limited in the number of image planes that can be projected and may have sub-optimal refresh rates.

### SUMMARY

As described above, existing multiplane 3D displays can be bulky, slow, and project a limited number of image planes. Accordingly, there is a need for improved multiplane 3D displays.

Described herein are systems and methods for projecting multiplane 3D images using a multiplane nanophotonic voxel engine. The multiplane nanophotonic voxel engine may include a laser light source and a photonic integrated circuit. The photonic integrated circuit may include a plurality of beam-steering cantilevers and a plurality of modulators. The plurality of beam-steering cantilevers may be piezoelectrically actuated beam-steering cantilevers. Each piezoelectrically actuated beam-steering cantilever may comprise a plurality of embedded waveguides that can emit light in various directions based on the actuation of the cantilever in order to generate a portion of an image.

According to various embodiments, the multiplane nanophotonic voxel engine provides several technical advantages. For example, the multiplane nanophotonic voxel engine described herein may enable projection of 3D images over more than 10 planes, each with 4K resolution over three or more wavelengths, with a contrast ratio of at least 10,000:1. Additionally, since the cantilevers used by the multiplane nanophotonic voxel engine are small (e.g., have diameters ten times thinner than a human hair), the beam-steering cantilevers may be lightweight and may be operated using ultra-low power (e.g., less than a milliwatt). According to various embodiments, by using a close-packed arrangement of these ultrathin cantilevers (e.g., 100 cantilevers per mm²), the multiplane nanophotonic voxel engine can achieve refresh rates of over 100,000 frames per second. Moreover, the multiplane nanophotonic voxel engine can achieve a pixel resolution higher than that achievable with existing multiplane light projection systems. According to various embodiments, the multiplane nanophotonic voxel engine can achieve an ultra-high pixel resolution (e.g., an in-plane density of 1 pixel/μm² across more than 10 vertically stacked planes, resulting in a 3D resolution in excess of 10,000,000 pixels/mm³ of display volume). The voxel density may also exceed 25,000 voxels per device. The device may also be ultracompact (e.g., about 1 mm²). These properties allow the multiplane nanophotonic voxel engine to be used in a variety of applications including AR/VR displays, multiplane displays, multiplane tweezers, multiplane microscopy, precision control of atomic memories, solid-state LiDAR capable of high-speed local and far-field imaging, quantum control, and holography.

In some embodiments, a multiplane nanophotonic voxel engine comprises a laser light source and a photonic integrated circuit, wherein the photonic integrated circuit comprises a plurality of beam-steering cantilevers and a plurality of modulators.

In some embodiments, the laser light source emits light having at least three different wavelengths.

In some embodiments, the laser light source comprises at least a red laser, a green laser, and a blue laser.

In some embodiments, the plurality of beam-steering cantilevers are piezoelectrically actuated beam-steering cantilevers.

In some embodiments, the piezoelectrically actuated beam-steering cantilevers comprise a piezoelectric film.

In some embodiments, the piezoelectrically actuated beam-steering cantilevers are actuated by applying a voltage to the piezoelectric film.

In some embodiments, the piezoelectrically actuated beam-steering cantilevers comprise a piezoelectric stack.

In some embodiments, the piezoelectrically actuated beam-steering cantilevers are actuated by applying a voltage to the piezoelectric stack.

In some embodiments, each beam-steering cantilever in the plurality of beam-steering cantilevers comprises one or more waveguides.

In some embodiments, the one or more waveguides emit modulated light.

In some embodiments, a first waveguide has a first length, and a second waveguide has a second length.

In some embodiments, selectively sending light to the first waveguide causes the first waveguide to emit light onto a first image plane.

In some embodiments the plurality of modulators are configured to distribute light to the plurality of beam-steering cantilevers.

In some embodiments, the plurality of modulators comprise broadband switches.

In some embodiments, the plurality of modulators comprise Mach-Zehnder interferometer switches.

In some embodiments, the multiplane nanophotonic voxel engine enables projection of light over at least ten image planes.

In some embodiments, each image plane has 4K resolution.

In some embodiments, the light comprises light having at least three different wavelengths.

In some embodiments, the multiplane nanophotonic voxel engine has a refresh rate of at least 100,000 frames per second.

In some embodiments, the multiplane nanophotonic voxel engine consumes less than one milliwatt of power per megavoxel.

In some embodiments, the photonic integrated circuit has an area less than 100 mm².

In some embodiments, a method comprises: receiving light from a laser light source; distributing the light to a plurality of beam-steering cantilevers, wherein each beam-steering cantilever comprises one or more waveguides; and actuating at least one of the plurality of beam-steering cantilevers to cause at least one of the one or more respective waveguides to emit light.

In some embodiments, the laser light source emits light having at least three different wavelengths.

In some embodiments, the laser light source comprises at least a red laser, a green laser, and a blue laser.

In some embodiments, the plurality of beam-steering cantilevers are piezoelectrically actuated beam-steering cantilevers.

In some embodiments, the piezoelectrically actuated beam-steering cantilevers comprise a piezoelectric film.

In some embodiments, the piezoelectrically actuated beam-steering cantilevers are actuated by applying a voltage to the piezoelectric film.

In some embodiments, the piezoelectrically actuated beam-steering cantilevers comprise a piezoelectric stack.

In some embodiments, the piezoelectrically actuated beam-steering cantilevers are actuated by applying a voltage to the piezoelectric stack.

In some embodiments, a first waveguide of the one or more waveguides has a first length, and a second waveguide of the one or more waveguides has a second length.

In some embodiments, selectively sending light to the first waveguide causes the first waveguide to emit light onto a first image plane.

In some embodiments, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A illustrates a side-view of a piezoelectrically actuated beam-steering cantilever, according to some embodiments.

FIG. 1B illustrates a top-view of a piezoelectrically actuated beam-steering cantilever, according to some embodiments.

FIG. 1C illustrates a multiplane nanophotonic voxel engine, according to some embodiments.

FIG. 1D illustrates an exemplary output of a multiplane nanophotonic voxel engine, according to some embodiments.

FIG. 2A illustrates a straight cantilever that may be used in a multiplane nanophotonic voxel engine, according to some embodiments.

FIG. 2B illustrates finite-element simulations of mechanical displacement for the eigenmode responsible for x-deflection of the straight cantilever, according to some embodiments.

FIG. 2C illustrates finite-element simulations of mechanical displacement for the eigenmode responsible for y-deflection of the straight cantilever, according to some embodiments.

FIG. 3A illustrates an L-shaped cantilever that may be used in a multiplane nanophotonic voxel engine, according to some embodiments.

FIG. 3B illustrates finite-element simulations of mechanical displacement for the eigenmode responsible for x-deflection of the L-shaped cantilever, according to some embodiments.

FIG. 3C illustrates finite-element simulations of mechanical displacement for the eigenmode responsible for y-deflection of the L-shaped cantilever, according to some embodiments.

FIG. 4A illustrates a fundamental vertical eigenmode for a cantilever with a tuning fork geometry that may be used in a multiplane nanophotonic voxel engine, according to some embodiments.

FIG. 4B illustrates an alternate vertical eigenmode for a cantilever with a tuning fork geometry that may be used in a multiplane nanophotonic voxel engine, according to some embodiments.

FIG. 4C illustrates a horizontal eigenmode for a cantilever with a tuning fork geometry that may be used in a multiplane nanophotonic voxel engine, according to some embodiments.

FIG. 5A illustrates a Mach-Zehnder interferometer (MZI) switch that may be used in a multiplane nanophotonic voxel engine, according to some embodiments.

FIG. 5B illustrates switching definitions and symbols for the MZI switch, according to some embodiments.

FIG. 6A illustrates a light color selection mechanism for a multiplane nanophotonic voxel engine, according to some embodiments.

FIG. 6B illustrates a standard color cycle, according to some embodiments.

FIG. 6C illustrates a color cycle generated by driving a color selection tree with only sinusoidal frequencies, according to some embodiments.

FIG. 7 illustrates an exemplary method of using a multiplane nanophotonic voxel engine, according to some embodiments.

### DETAILED DESCRIPTION

Disclosed herein are systems and methods for projecting multiplane 3D images using a multiplane nanophotonic voxel engine. The multiplane nanophotonic voxel engine may include a laser light source and a photonic integrated circuit. The photonic integrated circuit may include a plurality of beam-steering cantilevers and a plurality of modulators. The plurality of beam-steering cantilevers may be piezoelectrically actuated beam-steering cantilevers. Each piezoelectrically actuated beam-steering cantilever may comprise a plurality of embedded waveguides that can emit light in various directions based on the actuation of the cantilever in order to generate a portion of an image.

Reference will now be made in detail to implementations and embodiments of various aspects and variations of the systems and methods described herein. Although reference is sometime made herein to particular materials, dimensions and quantities it is appreciated that other materials, dimensions and quantities having similar functional and/or structural properties may be substituted where appropriate, and that after reading the disclosure provided herein, a person having ordinary skill in the art would understand how to select such materials, dimensions and quantities and incorporate them into embodiments of systems, circuits, devices using the concepts, techniques, and structures set forth herein without deviating from the scope of those teachings.

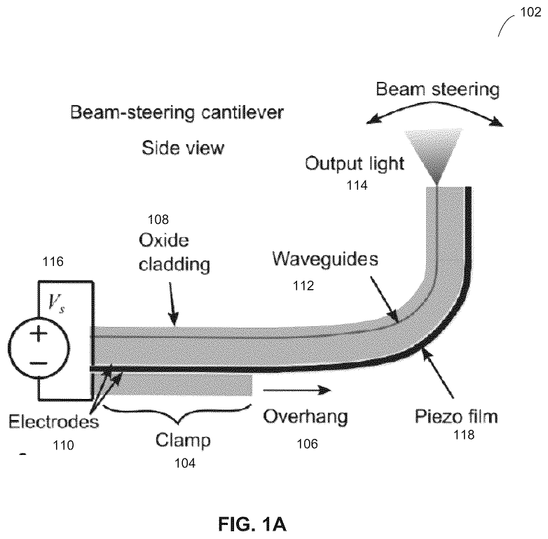

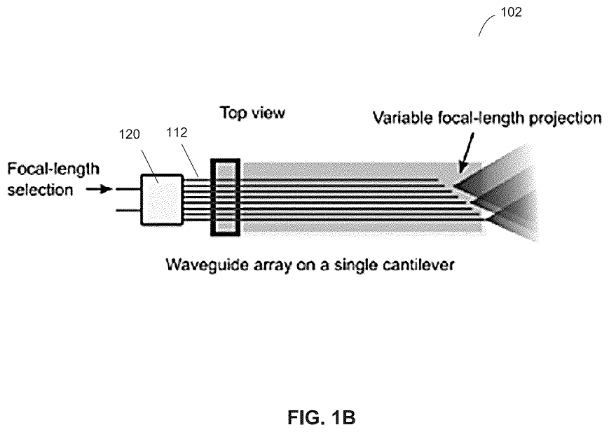

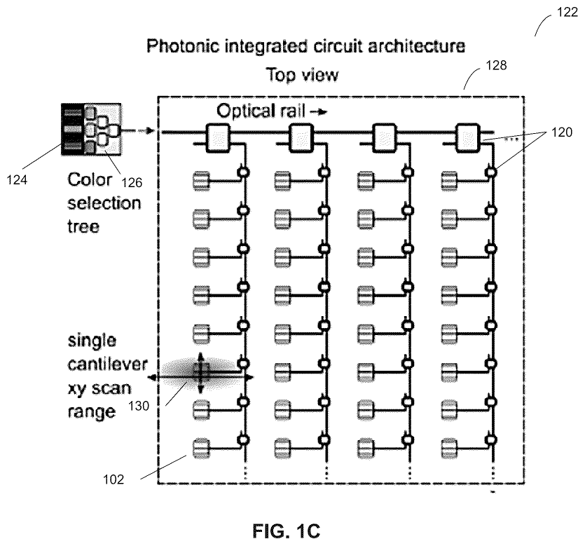

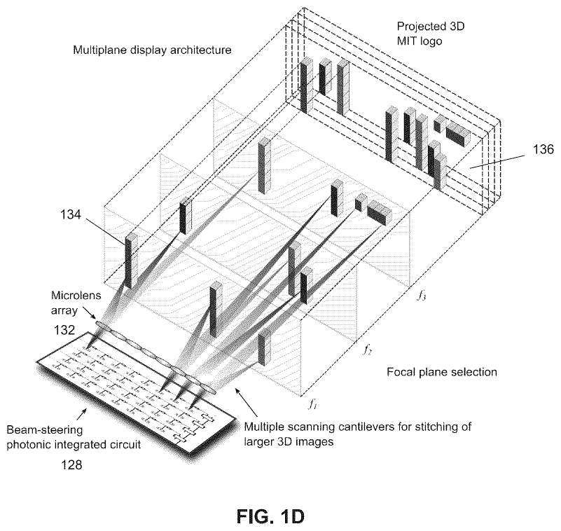

FIGS. 1A-1D illustrate various components and uses of a multiplane nanophotonic voxel engine, according to some embodiments. FIG. 1A illustrates a side view of a piezoelectrically actuated beam-steering cantilever 102, according to some embodiments. A first portion of the piezoelectrically actuated beam-steering cantilever 102 may be connected to a substrate (e.g., a chip) by a clamp 104, while a second overhang portion 106 of the piezoelectrically actuated beam-steering cantilever 102 may be capable of actuating in various directions. In some embodiments, the cantilever may be less than 100 μm in length. In some embodiments, the cantilever may be more than 100 μm in length.

The piezoelectrically actuated beam-steering cantilever 102 may further include a protective cladding 108. The cladding 108 may be an oxide cladding. The piezoelectrically actuated beam-steering cantilever can also include one or more electrodes 110, which can be used to actuate the cantilever 102. In some embodiments, a plurality of piezoelectrically actuated beam-steering cantilevers 102 can be disposed on a photonic integrated circuit (PIC) chip as part of a multiplane nanophotonic voxel engine.

As shown in FIG. 1A, a piezoelectrically actuated beam-steering cantilever 102 may further include a plurality of nanophotonic waveguides 112 which can emit modulated light 114 into free space. In some embodiments, a cantilever may comprise 2, 4, 6, 8, 10, or more than 10 waveguides. In some embodiments, a cantilever may comprise about 1-200 waveguides, about 50-150 waveguides, or about 100 waveguides. Each waveguide 112 can be selectively excited to generate different image planes. In some embodiments, the cantilever may comprise waveguides of varying lengths, as shown in FIG. 1B.

In some embodiments, beam-steering can be accomplished by applying a voltage 116 to a piezoelectric film 118 embedded in piezoelectrically actuated beam-steering cantilever 102. The piezoelectric film 118 may comprise a piezoelectric stack. The cantilever may be actuated by applying a voltage 116 to the piezoelectric stack to change the angle of the cantilever relative to the plane of the substrate (e.g., a photonic integrated circuit chip). In some embodiments, the piezoelectrically actuated beam-steering cantilever 102 may be strain-engineered to bend to near perpendicular to the plane of the substrate. In some embodiments, a global bulk piezoelectric actuator may be used to drive actuation instead of an integrated piezoelectric film. The global bulk piezoelectric actuator may be in contact with a photonic integrated circuit comprising a plurality of piezoelectrically actuated beam-steering cantilevers 102. By driving the global bulk piezoelectric actuator at one or more frequencies, one or more piezoelectrically actuated beam-steering cantilevers 102 may be selectively actuated based on the frequency. The mechanical quality factor Q can be manipulated to achieve strong coupling of the global bulk piezoelectric actuator to each individual piezoelectrically actuated beam-steering cantilever 102.

In some embodiments, actuating the piezoelectrically actuated beam-steering cantilever 102 causes the cantilever to scan over (e.g., point toward) an area, wherein the area scanned by the cantilever depends on the angle of the cantilever relative to the substrate. In some embodiments, the piezoelectrically actuated beam-steering cantilever 102 can scan over an area periodically. When the cantilever scans over an area, it can render a plurality of voxels by emitting light via the one or more waveguides 112. The color of each voxel rendered can be determined by a color selection tree, such as color selection tree 126 discussed below with reference to FIG. 1C. If the cantilever scans an area periodically, the one or more waveguides 112 of the cantilever can be configured to output a different color of light each time the cantilever scans over a given voxel. Because the cantilever can actuate rapidly (e.g., to provide a refresh rate of at least 100,000 frames per second), the color of a given voxel at different points in time may appear to the human eye to be one blended color rather than a sequence of individual colors. This can be attributed to the persistence of vision phenomenon, also referred to as flicker fusion, in which a human's visual perception of an image or visual stimulus lasts longer than the actual duration of the image or visual stimulus.

By scanning over a given area, a cantilever can render a plurality of voxels. The maximum number of voxels capable of being rendered by a single cantilever is:

$${N}_{v o x e l s} = \frac{{N}_{w g s} {W}_{x} {W}_{y}}{{w}^{{}_{2}}}$$

WₓW_{y} is the physical range of x and y scanning of the cantilever, respectively. w is the beam waist diameter at the output of the cantilever. N_{wgs} is the number of waveguides on a single cantilever, which represents the number of accessible focal planes. In some embodiments, N_{wgs} is greater than 10. For an estimated WₓW_{y}=50 μm and w=1 μm, the number of voxels rendered per cantilever is over 25,000 voxels. Assuming an array of 20×20 cantilevers, over 10,000,000 voxels, or over 10 planes with 1,000,000 pixels, can be rendered. In some embodiments, the cantilever can focus on a transverse spot size of ˜1 μm with a confocal parameter (equal to twice the Rayleigh length) of ˜10 μm. Thus, a voxel density of 0.1 voxels/μm³, or 100 million voxels per mm³, can be achieved. This is a significant improvement over a typical multiplane display, which has less than 100 voxels per mm³.

FIG. 1B illustrates a top view of piezoelectrically actuated beam-steering cantilever 102, according to some embodiments. As discussed above with reference to FIG. 1A, the piezoelectrically actuated beam-steering cantilever 102 may comprise a plurality of waveguides 112 capable of emitting light to generate different image planes. The waveguides 112 may be variable lengths. The lengths of the waveguides used in the cantilever can be chosen to obtain image planes at desired distances, given a certain choice of lens for the imaging system. In some embodiments, the lengths of the waveguides can vary on the order of the focal length of the selected lens. In some embodiments, the selected lens is a microlens with μm-scale focal lengths.

A piezoelectrically actuated beam-steering cantilever 102 can project light onto a specific plane by selectively sending light to one of the variable-length waveguides 112 that corresponds to the desired plane. The light may be modulated by a modulator 120. In some embodiments, the modulator 120 may be an optical switch, such as a Mach-Zehnder interferometer (MZI) switch or a broadband MZI switch. The modulated light may then be routed to the waveguide corresponding to the selected object/image plane. In some embodiments, modulated light may be routed to one waveguide 112 of a given piezoelectrically actuated beam-steering cantilever 102 at a time.

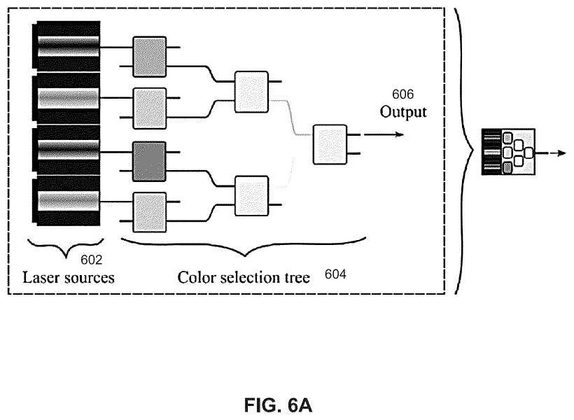

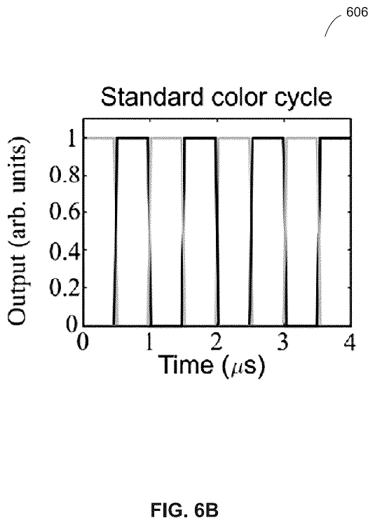

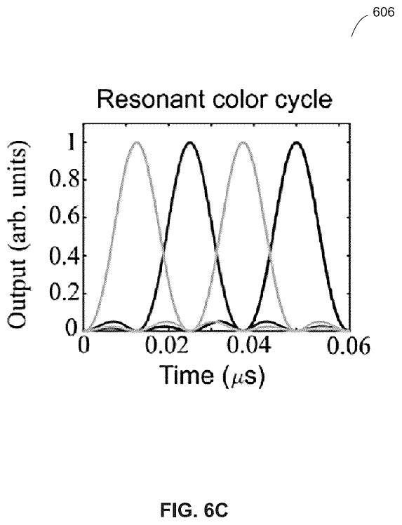

FIG. 1C illustrates a multiplane nanophotonic voxel engine, according to some embodiments. The multiplane nanophotonic voxel engine 122 may comprise a laser light source 124, a color selection tree 126, and a photonic integrated circuit 128. Laser light source 124 may provide light to color selection tree 126. In some embodiments, laser light source 124 is a multicolor laser. The multicolor laser may comprise a red laser, a green laser, and a blue laser to enable a full color display. Color selection tree 126 may comprise a plurality of modulators (e.g., optical switches) that can be configured to output a specified color of light at a specified time, as will be discussed below with reference to FIG. 6A. In some embodiments, the output from color selection tree 126 comprises a specified color cycle (e.g., a specified sequence of colors to be output at certain times).

The output from color selection tree 126 may be provided to photonic integrated circuit 128. Photonic integrated circuit 128 may then distribute the light from color selection tree 126 to a plurality of piezoelectrically actuated beam-steering cantilevers 102 disposed on the photonic integrated circuit chip. Photonic integrated circuit 128 may include a plurality of modulators 120 (as shown in FIG. 1B), which can modulate the intensity of the light distributed to each piezoelectrically actuated beam-steering cantilever 102. In some embodiments, the modulators 120 may be Mach-Zehnder interferometer switches. In some embodiments, the modulators 120 may be broadband optical switches. In some embodiments, the broadband optical switches may be visible-wavelength switches that operate at blue (405 nm), green (532 nm), and red (633 nm) wavelengths. In some embodiments, when the light modulated by the modulators 120 is provided to the plurality of piezoelectrically actuated beam-steering cantilevers 102, the plurality of piezoelectrically actuated beam-steering cantilevers 102 can actuate, which causes the light-emitting waveguides 112 to project light in a certain direction based on the angle of actuation of the respective cantilever. The piezoelectrically actuated beam-steering cantilevers 102 can actuate in the x and y directions. In some embodiments, each piezoelectrically actuated beam-steering cantilever 102 can scan through an x-y area 130 defined by the angular tunability. The piezoelectrically actuated beam-steering cantilevers may be spaced such that each cantilever's in-plane deflection range covers all gaps between cantilevers, resulting in no dead space for every image plane of the display. The resulting design allows construction of a large number of distinct free-space modes at high speed, enabling the cantilevers to work in tandem to project high resolution images by stitching together individual voxels.

In some embodiments, the multiplane nanophotonic voxel engine 122 can direct light through an imaging system, such as imaging system 132 as will be described below with reference to FIG. 1D. After passing through the imaging system 132, the light may converge at a location in space to render a voxel. By rendering a plurality of voxels, a multiplane 3D image can be displayed. In some embodiments, the multiplane nanophotonic voxel engine 122 may be integrated into a device, such as a virtual reality (VR) headset, a drone, a projector, a smartphone, a tablet, or a laptop computer, to enable display of 3D images.

In some embodiments, the multiplane nanophotonic voxel engine 122 may comprise one or more embedded processing units and at least one embedded memory unit. The one or more embedded processing units may include central processing units (CPUs), graphics processing units (GPUs), or a combination thereof. The at least one embedded memory unit may be any memory unit configured to provide storage, such as an electrical, magnetic, or optical memory unit. Programs or instructions for projecting a multiplane 3D image may be stored in the at least one embedded memory unit for execution by the one or more embedded processing units. In some embodiments, the programs or instructions may include voltage settings corresponding to a 3D image. The voltage settings may specify voltages for various components of the multiplane nanophotonic voxel engine 122, including the laser light source 124, the color selection tree 126, and the components of photonic integrated circuit 128 (e.g., the piezoelectrically actuated beam-steering cantilevers 102 and the modulators 120). In some embodiments, the voltage settings may be provided to a digital-to-analog converter (DAC), which can output the voltage settings to the various components of multiplane nanophotonic voxel engine 122 to project a multiplane 3D image.

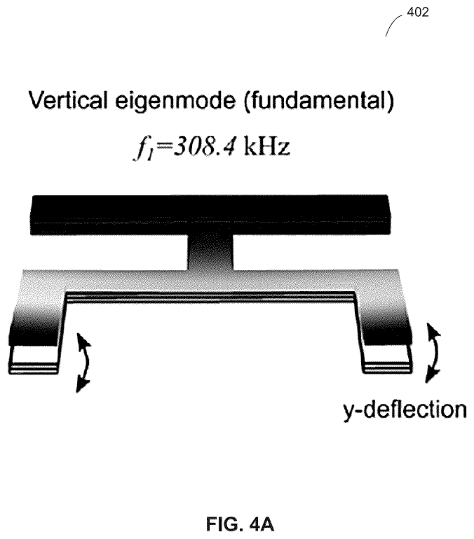

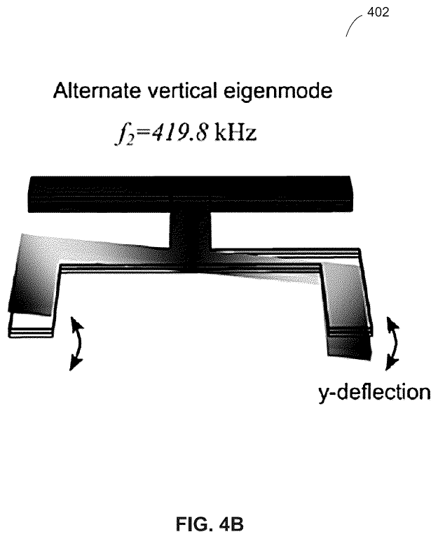

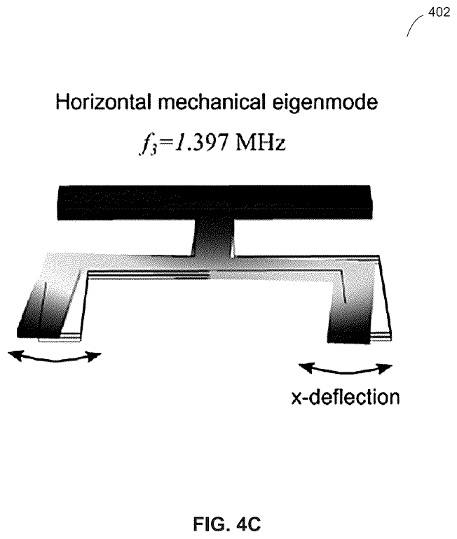

In some embodiments, the multiplane nanophotonic voxel engine 122 may have a low power consumption (e.g., less than 1 mW per megavoxel). Scanning at typical eigenfrequencies of the order ˜1 MHZ, each piezoelectrically actuated beam-steering cantilever 102 in multiplane nanophotonic voxel engine 122 would consume only 20 μW of electrical power. For a 20×20 grid of cantilevers (10 million voxels) the electrical power consumption would be 0.8 mW/MVoxel. Power consumption may be additionally reduced by scanning at lower spends or engineering higher quality factor Q mechanical resonators (e.g., cantilevers with tuning fork geometries, as shown in FIGS. 4A-4C).

FIG. 1D illustrates an exemplary output of a multiplane nanophotonic voxel engine, according to some embodiments. As discussed in FIG. 1C, a multiplane nanophotonic voxel engine 122 can include a laser light source 124, a color selection tree 126, and a photonic integrated circuit 128. Light from laser light source 124 may be input to color selection tree 126, which can output a color cycle indicating which color(s) of light should be output by the waveguides 112 of the cantilevers 102 on photonic integrated circuit 128. The multiplane nanophotonic voxel engine 122 may be configured to direct light through an imaging system 132. In some embodiments, imaging system 132 can be a microlens array. In some embodiments, a standard macroscopic lens can be used instead of a microlens array. In some embodiments, integrated lenses written directly onto the cantilever structure can be used in conjunction with a microlens array or a single larger lens to reduce the complexity of the device. Laser annealing or direct 3D printing may be used to generate the integrated lenses.

In some embodiments, the multiplane nanophotonic voxel engine 122 can be configured to generate 3D images by rendering a plurality of voxels 134 in various image planes. A voxel 134 can be rendered when light that passes through the imaging system 132 converges at a location in space. In some embodiments, because the cantilevers 102 of photonic integrated circuit 128 can actuate rapidly, the color of a given voxel 134 may change faster than a human eye can refresh. Thus, a given voxel rendered by a cantilever of photonic integrated circuit 128 may appear to be a different color at a given time than the color actually being output at that time, since the individual colors of light output by the cantilever can mix together faster than the eye can detect.

Multiplane 3D image generation can be achieved by stitching sub-images (e.g., voxels) generated by all cantilevers on the chip. For example, as shown in FIG. 1D, a 3D image 136 of an MIT logo can be generated by stitching together the voxels 134 generated by the individual cantilevers 102 of photonic integrated circuit 128.

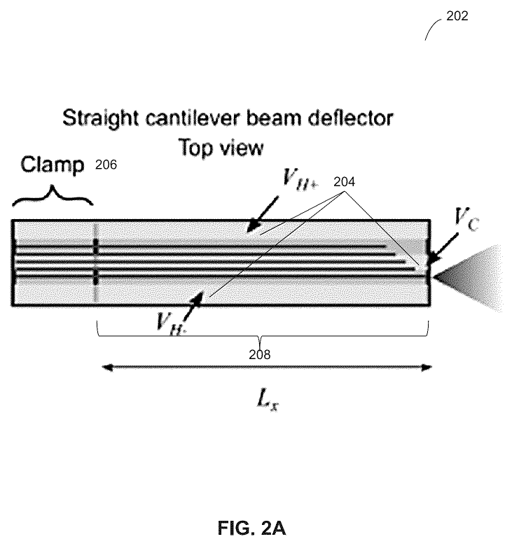

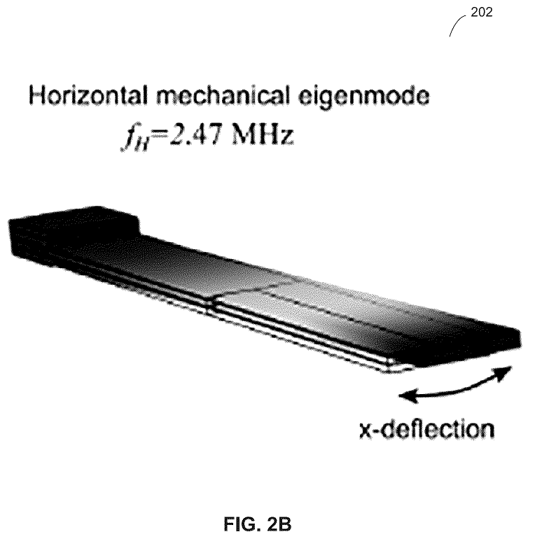

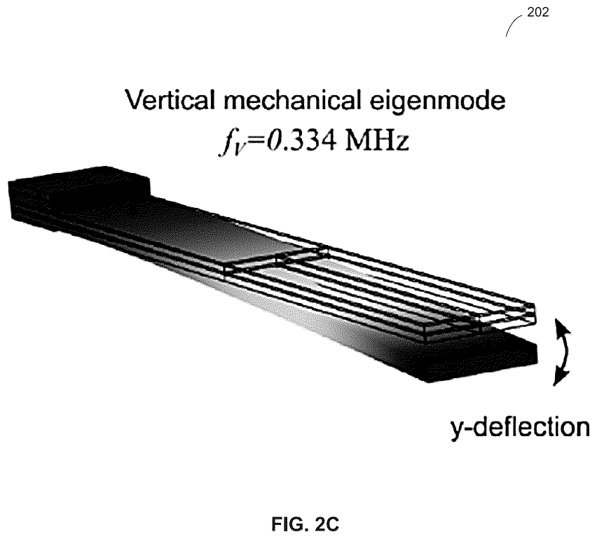

FIGS. 2A-2C illustrate an exemplary cantilever, which may share any one or more characteristics with piezoelectrically actuated beam-steering cantilever 102 described above with reference to FIGS. 1A-1D. FIG. 2A illustrates a straight cantilever 202, according to some embodiments. As shown, the straight cantilever 202 may comprise three electrodes 204, V_{H+}, V_{H-}, and V_{c} . . . . The electrodes 204 may be used to actuate the cantilever 202 in both the x and y directions. The cantilever 202 may further comprise a clamp 206 by which the cantilever can be connected to a substrate (e.g., a chip, such as photonic integrated circuit 128 described above with reference to FIG. 1C) and an overhang portion 208 that can be actuated in the x and y directions. In some embodiments, the length Lₓ of overhang portion 208 can be adjusted to target a desired eigenmode frequency or DC actuation strength.

FIGS. 2B and 2C illustrate finite element simulations of mechanical displacement for AC eigenmodes of an exemplary straight cantilever 202 with an overhang length Lₓ of 60 μm. FIG. 2B illustrates the x-deflection (horizontal) eigenmode f_{H}, wherein f_{H}=2.47 MHz. FIG. 2C illustrates the y-deflection (vertical) eigenmode f_{V}, wherein f_{V}=334 kHz. In the example shown in FIGS. 2B and 2C, the x-deflection eigenmode is approximately seven times as fast as the y-deflection eigenmode.

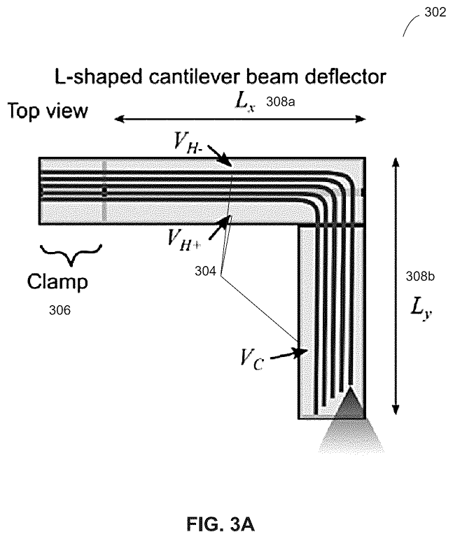

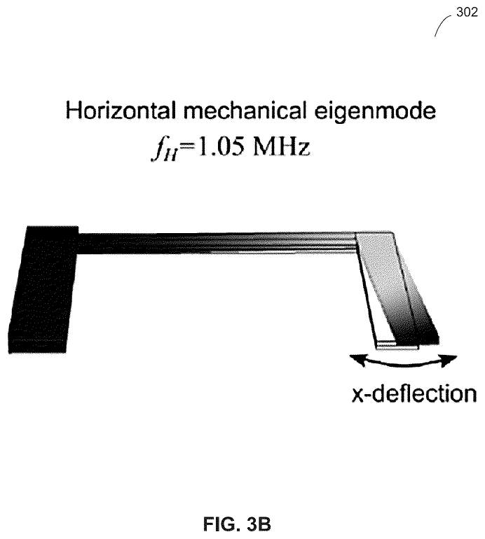

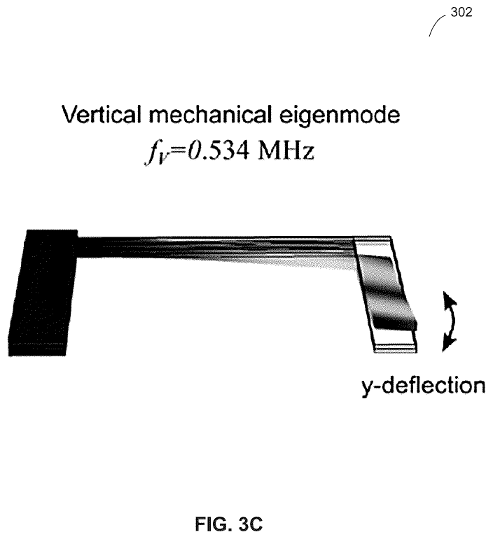

FIGS. 3A-3C illustrate another exemplary cantilever. FIG. 3A illustrates an L-shaped cantilever 302, according to some embodiments. An L-shaped design may be used to facilitate superior beam steering and to obtain x horizontal and vertical eigenmodes that are more similar in frequency than those described above with reference to FIGS. 2B and 2C. The L-shaped cantilever 302 may comprise three distinct electrodes 304, V_{H+}, V_{H-}, and V_{c}, allowing full DC control of the beam deflection depending on the combination and polarity of applied voltages. The cantilever 302 may further comprise a clamp 306 by which the cantilever can be connected to a substrate (e.g., a chip, such as photonic integrated circuit 128 described above with reference to FIG. 1C) and horizontal and vertical overhang portions 308a and 30b that can be actuated in the x and y directions, respectively. In some embodiments, the overhang lengths Lₓ and L_{y} can be adjusted can be adjusted to target a desired eigenmode frequency or DC actuation strength.

FIGS. 3B and 3C illustrate finite element simulations of mechanical displacement for AC eigenmodes of an exemplary L-shaped cantilever 302 with x-direction and y-direction overhang lengths Lₓ=L_{y}=50 μm. FIG. 3B illustrates the x-deflection (horizontal) eigenmode f_{H}, wherein f_{H}=1.05 MHz. FIG. 3C illustrates the y-deflection (vertical) eigenmode f_{V}, wherein f_{V}=0.534 MHz. In the example shown in FIGS. 3B and 3C, the x-deflection eigenmode is approximately twice as fast as the y-deflection eigenmode.

FIGS. 4A-4C illustrate finite element simulations of mechanical displacement for AC eigenmodes of another exemplary cantilever 402 with a tuning fork geometry. Cantilevers with tuning fork geometries may have higher mechanical quality factors (Q) compared with other geometries and allow for two steering beams in a more compact footprint. Operation of the beam steering for tuning fork cantilevers is similar to operation of the beam steering for L-shaped cantilevers: exciting a vertical and horizontal combination of eigenmodes scans the entire 2D projection plane.

FIG. 4A illustrates the fundamental y-deflection (vertical) eigenmode f₁, wherein f₁=308.4 kHz. The fundamental vertical eigenmode corresponds to vertical deflections of both arms of the cantilever simultaneously. FIG. 4B illustrates the alternate y-deflection (vertical) eigenmode f₂, wherein f₂=419.8 kHz. The alternate vertical eigenmode corresponds to vertical deflections of the arms of the cantilever in an alternating fashion. FIG. 4C illustrates the x-deflection (horizontal) eigenmode f_{H}, wherein f_{H}=1.397 MHz. The horizontal eigenmode corresponds to horizontal deflections of both arms of the cantilever simultaneously.

By selectively driving both x and y eigenmodes, it is possible to cyclically scan a light beam in a predictable 2D pattern at high speeds. This pattern can then be synchronized with the color selection tree of a multiplane nanophotonic voxel engine, described above with reference to FIGS. 1C and 1D, to render any desired image or address any individual voxel. Spatial scanning speeds are defined by the x and y eigenfrequencies. In some embodiments, response times are about 1 μs-10 μs. Color and focal length selection scanning speeds may be defined by the response times of broadband optical switches, which can operate at sub-μs time-frames.

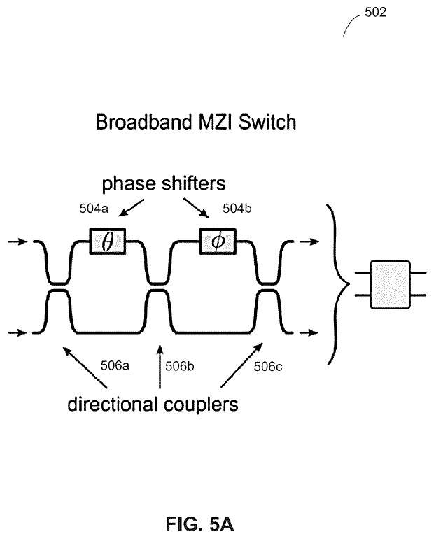

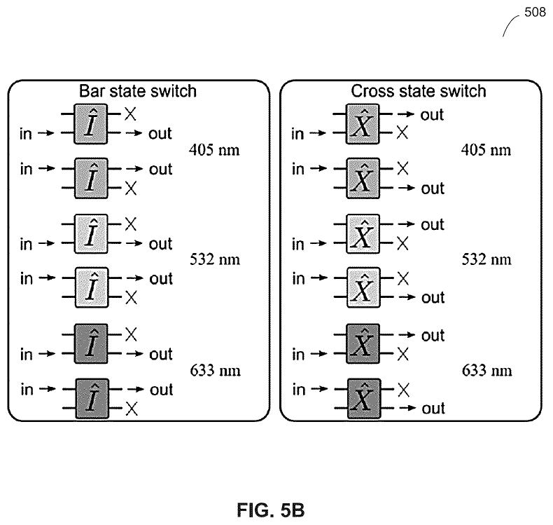

FIG. 5A illustrates an exemplary Mach-Zehnder interferometer (MZI) switch 502 that may be used in a multiplane nanophotonic voxel engine, according to some embodiments. The MZI switch 502 may be a modified MZI switch consisting of two phase shifters θ and ϕ (504a and 504b, respectively) and three directional couplers 506a-c. In some embodiments, MZI switch 502 is a broadband visible wavelength switch that can switch between blue (405 nm), green (532 nm), and red (633 nm) wavelengths. A chart 508 of switching definitions and symbols for these three colors (blue, green, and red) is shown in FIG. 5B. In some embodiments, MZI switch 502 may be a modulator used in a photonic integrated circuit of a multiplane nanophotonic voxel engine, such as modulator 120 discussed above with reference to FIG. 1C. In some embodiments, MZI switch 502 may be used in a color selection tree, such as color selection tree 126 discussed above with reference to FIG. 1C.

The design of MZI switch 502 shown in FIG. 5A is tolerant to variations in the directional couplers 506a-c due to fabrication and dispersion across the large optical bandwidth. By using longer designs, directional couplers 506a-c can be tuned to within a 25:75 range for all three wavelengths, which would still enable theoretically perfect switching performance for correct settings of phase shifters θ (504a) and ϕ (504b).

FIG. 6A illustrates a light color selection mechanism for a multiplane nanophotonic voxel engine, according to some embodiments. As discussed above with reference to FIG. 1C, the multiplane nanophotonic voxel engine described herein may comprise a laser light source and a color selection tree for determining which light color(s) will be projected at specified times. The laser light source may comprise a multicolor laser source 602, which may comprise at least a red laser, a green laser, and a blue laser to enable a full color display. In some embodiments, multicolor laser source 602 may comprise more than three colored lasers (e.g., multicolor laser source 602 may include a red laser, a blue laser, and two green lasers). The light from multicolor laser source 602 can be received by a color selection tree 604, which can select which color(s) to output (e.g., blue, green, or red), the intensity of the colored light to be output, and how long each colored light should be displayed.

As shown in FIG. 6A, the color selection tree 604 may comprise a series of cascaded MZI switches, such as MZI switches 502 described above with reference to FIG. 5A. Color selection tree 604 may share any one or more characteristics with color selection tree 126 described above with reference to FIG. 1C. In some embodiments, one or more of the MZI switches in color selection tree 604 may be broadband MZI switches. In some embodiments, a first set of MZI switches may be used to control the intensity of light from each of laser in multicolor laser source 602. A second set of MZI switches may be used to combine light output by the first column of switches. For instance, a first MZI switch in the second set of MZI switches may combine green and blue light and output a first combined light color, while a second MZI switch in the second set of MZI switches may combine red and green light and output a second combined light color. A third column may comprise a final switch that can combine the first combined light color and the second combined light color to produce a final colored light output. In some embodiments, the color selection tree 604 may output a color cycle 606 that can specify which color(s) of light should be output by the multiplane nanophotonic voxel engine at specified times.

FIGS. 6B and 6C illustrate exemplary color cycles 606 output by the color selection tree 604. The color cycles generated depend on how the color selection tree 604 is driven. FIG. 6B illustrates a standard color cycle 606, according to some embodiments. FIG. 6C illustrates a resonant color cycle 606 generated by driving the color selection tree 604 with only sinusoidal frequencies, according to some embodiments.

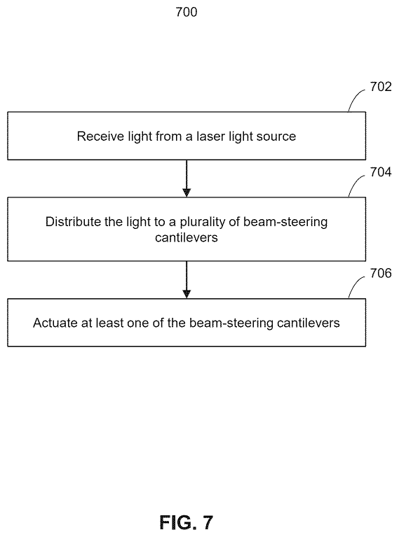

FIG. 7 illustrates an exemplary method of using a multiplane nanophotonic voxel engine, according to some embodiments. In method 700, some blocks are, optionally combined; the order of some blocks is, optionally, changed; and some blocks are, optionally, omitted. Accordingly, the operations as illustrated (and described in greater detail below) are exemplary by nature and, as such, should not be viewed as limiting.

The method 700 may begin with step 702, wherein step 702 comprises receiving light from a laser light source. The laser light source may share any one or more characteristics with laser light source 124 described above with reference to FIG. 1C. In some embodiments, the laser light source may be a multicolor laser with at least a blue laser, a green laser, and a red laser.

In some embodiments, the light from the laser light source is fed to a color selection tree, such as color selection tree 126 described above with reference to FIG. 1C. The color selection tree may select the color and intensity of light to be output by a multiplane nanophotonic voxel engine.

The method 700 may proceed to step 704, wherein step 704 comprises distributing the light to a plurality of beam-steering cantilevers. In some embodiments, light may be received from the color selection tree at a photonic integrated circuit, such as photonic integrated circuit 128 described above with reference to FIG. 1C. The photonic integrated circuit may comprise a plurality of beam-steering cantilevers and a plurality of modulators. In some embodiments, the intensity of the light received from the color selection tree is modulated by the plurality of modulators before being distributed to the plurality of beam-steering cantilevers. In some embodiments, the beam-steering cantilevers are piezoelectrically actuated beam-steering cantilevers, such as piezoelectrically actuated beam-steering cantilevers 102 described above with reference to FIGS. 1A-1D. Each beam-steering cantilever may comprise one or more waveguides. The one or more waveguides may be capable of emitting light.

The method 700 may then proceed to step 706. Step 706 includes actuating at least one of the beam-steering cantilevers. In some embodiments, actuating a beam-steering cantilever is accomplished by applying a voltage to a piezoelectric film embedded in the beam-steering cantilever. The piezoelectric film may comprise a piezoelectric stack. The cantilever may be actuated by applying a voltage to the piezoelectric stack to change the angle of the cantilever relative to the plane of the photonic integrated circuit chip. Actuating a beam-steering cantilever causes at least one of the waveguides associated with the beam-steering cantilever to emit the light that was distributed to the beam-steering cantilever. The waveguide may emit light in a direction determined by the angle at which the beam-steering cantilever actuates. In some embodiments, the light can pass through an imaging system and converge at a location in space to render a voxel. Thus, by actuating multiple cantilevers at once, a plurality of voxels can be rendered across a plurality of image planes. The planes can then be viewed in combination to render a multiplane 3D image.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A multiplane nanophotonic voxel engine comprising:
a laser light source; and
a photonic integrated circuit, wherein the photonic integrated circuit comprises a plurality of beam-steering cantilevers and a plurality of modulators.

2. The multiplane nanophotonic voxel engine of claim 1, wherein the laser light source emits light having at least three different wavelengths.

3. The multiplane nanophotonic voxel engine of claim 1, wherein the laser light source comprises at least a red laser, a green laser, and a blue laser.

4. The multiplane nanophotonic voxel engine of claim 1, wherein the plurality of beam-steering cantilevers are piezoelectrically actuated beam-steering cantilevers.

5. The multiplane nanophotonic voxel engine of claim 4, wherein the piezoelectrically actuated beam-steering cantilevers comprise a piezoelectric film.

6. The multiplane nanophotonic voxel engine of claim 5, wherein the piezoelectrically actuated beam-steering cantilevers are actuated by applying a voltage to the piezoelectric film.

7. The multiplane nanophotonic voxel engine of claim 4, wherein the piezoelectrically actuated beam-steering cantilevers comprise a piezoelectric stack.

8. The multiplane nanophotonic voxel engine of claim 7, wherein the piezoelectrically actuated beam-steering cantilevers are actuated by applying a voltage to the piezoelectric stack.

9. The multiplane nanophotonic voxel engine of claim 1, wherein each beam-steering cantilever in the plurality of beam-steering cantilevers comprises one or more waveguides.

10. The multiplane nanophotonic voxel engine of claim 9, wherein the one or more waveguides emit modulated light.

11. The multiplane nanophotonic voxel engine of claim 9, wherein a first waveguide has a first length, and a second waveguide has a second length.

12. The multiplane nanophotonic voxel engine of claim 11, wherein selectively sending light to the first waveguide causes the first waveguide to emit light onto a first image plane.

13. The multiplane nanophotonic voxel engine of claim 1, wherein the plurality of modulators are configured to distribute light to the plurality of beam-steering cantilevers.

14. The multiplane nanophotonic voxel engine of claim 1, wherein the plurality of modulators comprise broadband switches.

15. The multiplane nanophotonic voxel engine of claim 1, wherein the plurality of modulators comprise Mach-Zehnder interferometer switches.

16. The multiplane nanophotonic voxel engine of claim 1, wherein the multiplane nanophotonic voxel engine enables projection of light over at least ten image planes.

17. The multiplane nanophotonic voxel engine of claim 16, wherein each image plane has 4K resolution.

18. The multiplane nanophotonic voxel engine of claim 16, wherein the light comprises light having at least three different wavelengths.

19. The multiplane nanophotonic voxel engine of claim 1, wherein the multiplane nanophotonic voxel engine has a refresh rate of at least 100,000 frames per second.

20. The multiplane nanophotonic voxel engine of claim 1, wherein the multiplane nanophotonic voxel engine consumes less than one milliwatt of power per megavoxel.

21. The multiplane nanophotonic voxel engine of claim 1, wherein the photonic integrated circuit has an area less than 100 mm².

22. A method comprising:
receiving light from a laser light source;
distributing the light to a plurality of beam-steering cantilevers, wherein each beam-steering cantilever comprises one or more waveguides; and
actuating at least one of the plurality of beam-steering cantilevers to cause at least one of the one or more respective waveguides to emit light.

23. The method of claim 22, wherein the laser light source emits light having at least three different wavelengths.

24. The method of claim 22, wherein the laser light source comprises at least a red laser, a green laser, and a blue laser.

25. The method of claim 22, wherein the plurality of beam-steering cantilevers are piezoelectrically actuated beam-steering cantilevers.

26. The method of claim 25, wherein the piezoelectrically actuated beam-steering cantilevers comprise a piezoelectric film.

27. The method of claim 26, wherein the piezoelectrically actuated beam-steering cantilevers are actuated by applying a voltage to the piezoelectric film.

28. The method of claim 25, wherein the piezoelectrically actuated beam-steering cantilevers comprise a piezoelectric stack.

29. The method of claim 28, wherein the piezoelectrically actuated beam-steering cantilevers are actuated by applying a voltage to the piezoelectric stack.

30. The method of claim 22, wherein a first waveguide of the one or more waveguides has a first length, and a second waveguide of the one or more waveguides has a second length.

31. The method of claim 30, wherein selectively sending light to the first waveguide causes the first waveguide to emit light onto a first image plane.
